(19) United States
(12) Patent Application Publication
(10) Pub. No.: US 2011/0122146 A1
(43) Pub. Date: May 26, 2011

(54) SYSTEMS AND METHODS FOR MATCHING MEDICAL IMAGES

(75) Inventors: Yao Nie, Sunnyvale, CA (US); Chao Shi, San Jose, CA (US); Nariman Majdi-Nasab, San Jose, CA (US); Akira Hasegawa, Saratoga, CA (US)

(73) Assignee: FUJIFILM Corporation, Tokyo (JP)

(21) Appl. No.: 12/626,602

(22) Filed: Nov. 25, 2009

(51) Int. Cl. G09G 5/02

(52) U.S. Cl. 345/589; 382/128; 345/617

(57) ABSTRACT

A system and method is provided for matching visual features in at least two related medical images. The differences in visual features between at least two related images are identified, such as separate mammography images of a left breast and a right breast of a patient. The visual features may include the image brightness, contrast, sharpness (or edge strength), alignment or dynamic range. The visual features of at least one of the images is then adjusted to match the visual features of the other image, or both images are adjusted to match a predefined value of visual features for a medical image. The adjusted images may then be displayed to a user, such as a radiologist or technician, who is able to more accurately identify physiological inconsistencies between the two images now that they have similar underlying visual features.

### BACKGROUND

1. Field

The systems and methods described below relate to adjusting medical images, and more specifically to matching visual features of a plurality of related medical images such as a mammography images.

2. Background

Medical imaging is the field of creating images of the human body for medical purposes, such as diagnosing or examining disease or other physiological anomalies. Numerous types of image modalities produce medical images, such as magnetic resonance imaging (MRI), radiography (x-rays), computed tomography (CT), ultrasound (US) and others. In medical imaging, an object of interest is usually selected pertaining to an area of the human body, such as the head, heart or chest.

One type of medical imaging is mammography, which is the examination of a medical image of the human breast. Mammography is used to detect breast cancer by examining the breast tissue for abnormalities such as microcalcifications or uncharacteristic masses.

In the process of reading digital mammography images, a user, such as a radiologist, often needs to compare two similar images to detect the abnormalities, such as comparing two images of the same breast taken at different times, comparing two images of the same breast taken from different angles (e.g., cranio-caudal vs. medio-lateral or medio-lateral oblique), or comparing two images where a first image depicts a left breast while a second image depicts a right breast. Visual features of the different mammography images, such as the brightness and contrast, may appear different to the radiologist due to various acquisition conditions, the type of machine being used to capture the image, or image processing algorithms that are applied to the image after it is captured. The radiologist often will manually adjust the brightness or contrast of one of the images to a level similar to a second image for easier comparison. However, this manual adjustment may be difficult and tedious, and require a significant amount of time to reach a desired level, thus increasing the work load of the radiologist. Furthermore, the radiologist may only be able to adjust a few visual features due to time constraints or limitations of manual image processing, even though the images may have significant other differences between a variety of visual features. The radiologist may also be limited in the ability to adjust the visual features of the images to an appropriately similar level. All in all, any type of manual image adjustment is time consuming, discouraging the radiologist from attempting to obtain the clearest possible image with the best chance of diagnosing any potential abnormalities.

Thus, there is an unmet need to develop systems and methods for effectively and efficiently matching the visual features of related medical images.

### SUMMARY

Various embodiments of the invention relate to systems and methods for adjusting medical images, and more specifically to matching visual features of a plurality of related medical images such as a mammography images. Differences in visual features are identified between at least two related medical images, after which the visual features of at least one of the medical images is adjusted to reduce the differences and match the visual features of the medical images. The medical images are then displayed to a user on a display.

One aspect of certain embodiments of the invention relates to a method for matching visual features of a plurality of medical images, comprising identifying differences between visual features in at least two medical images; adjusting at least one of the visual features of at least one of the medical images to reduce the differences between the visual features of the at least two medical images; and displaying the at least two medical images on a display.

In another embodiment of the invention, the differences between visual features in the at least two medical images are automatically identified.

In another embodiment of the invention, the at least one of the visual features of at least one of the medical images is automatically adjusted.

In another embodiment of the invention, the medical images are mammography images, and wherein a first mammography image depicts a left breast of a patient, and wherein a second mammography image depicts a right breast of the patient.

In another embodiment of the invention, the medical images are mammography images, and wherein a first mammography image depicts a breast of a patient taken at a first time, and wherein a second mammography image depicts the breast of the patient taken at a subsequent time.

In another embodiment of the invention, the visual features include at least one of brightness, contrast, sharpness (or edge strength) and dynamic range.

In another embodiment of the invention, the visual features are adjusted through at least one of histogram shifting, histogram equalization (or intensity value mapping), and Unsharp Masking.

In another embodiment of the invention, the visual features to be adjusted are selected by a user.

In another embodiment of the invention, the at least one of the visual features of the at least one medical images is adjusted to a predefined value, wherein the predefined value may be unique for each visual feature.

In another embodiment of the invention, the at least one of the visual features of the at least one medical images is adjusted to match at least one of the visual features of another of the at least two medical images.

Embodiments of the invention also relate to a system for matching visual features of a plurality of medical images, comprising an identification unit which identifies differences between visual features in at least two medical images; and an adjustment unit which adjusts at least one of the visual features of at least one of the medical images to reduce the differences between the visual features of the at least two medical images.

In another embodiment of the invention, the system further comprises a display unit which displays the at least two medical images after said adjusting is performed.

In another embodiment of the invention, the differences between visual features in the at least two medical images are automatically identified.

In another embodiment of the invention, the at least one of the visual features of at least one of the medical images is automatically adjusted.

In another embodiment of the invention, the medical images are mammography images, and wherein a first mammography image depicts a left breast of a patient, and wherein a second mammography image depicts a right breast of the patient.

In another embodiment of the invention, the medical images are mammography images, and wherein a first mammography image depicts a breast of a patient taken at a first time, and wherein a second mammography image depicts the breast of the patient taken at a subsequent time.

In another embodiment of the invention, the visual features include at least one of brightness, contrast, sharpness (or edge strength) and dynamic range.

In another embodiment of the invention, the visual features are adjusted through at least one of histogram shifting, histogram equalization (or intensity value mapping) and Unsharp Masking.

In another embodiment of the invention, the visual features to be adjusted are selected by a user.

In another embodiment of the invention, the at least one of the visual features of the at least one medical images is adjusted to a predefined value, wherein the predefined value may be unique for each visual feature.

In another embodiment of the invention, the at least one of the visual features of the at least one medical images is adjusted to match at least one of the visual features of another of the at least two medical images.

Embodiments of the invention also related to a computer program product for matching visual features of a plurality of medical images, the computer program product embodied on a computer readable medium and when executed by a computer, performs the method comprising: identifying differences between visual features in at least two medical images; adjusting at least one of the visual features of at least one of the medical images to reduce the differences between the visual features of the at least two medical images; and displaying the at least two medical images on a display after said adjusting is performed.

Additional embodiments related to the invention will be set forth in part in the description which follows, and in part will be apparent from the description, or may be learned by practice of the invention. Embodiments of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify various embodiments of the present invention and, together with the description, serve to explain and illustrate principles of the inventive technique. Specifically:

FIG. 1A depicts a first mammography image of a left breast and a second mammography image of a right breast, as is known in the art;

FIG. 1B depicts the first mammography image and second mammography image of FIG. 1A, where visual features of the right mammography image have been adjusted to match the visual features of the left mammography image, according to one embodiment of the invention;

FIG. 2A depicts a first mammography image with a cranio-caudal (CC) view of a breast and a second mammography image with a medio-lateral oblique (MLO) view of the breast, as is known in the art;

FIG. 2B depicts the first mammography image with the CC view and second mammography image with the MLO view of FIG. 2A, where visual features of the second mammography image with the MLO view have been adjusted to match the visual features of the first mammography image with the CC view;

FIG. 3A depicts a first mammography image of a breast taken from a medio-lateral (ML) view and a second mammography image of the same breast that was taken at a different time, as is known in the art;

FIG. 3B depicts the first mammography image of a breast and the second mammography image of the same breast which is taken at a different time, where visual features of the first mammography image have been adjusted to match the visual features of the second mammography image, according to one embodiment of the invention;

FIGS. 4A-4C depict methods of matching visual features in a plurality of medical images, according to various embodiments of the invention;

FIG. 5 illustrates a system for matching visual features in a plurality of medical images, according to one embodiment of the invention; and

FIG. 6 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware. Expressions such as “at least one of,” when preceding a list of elements, modifies the entire list of elements and does not modify each element of the list.

Various embodiments of the invention relate to systems and methods for adjusting medical images, and more specifically to matching visual features of a plurality of related medical images such as a mammography images. Differences in visual features are identified between at least two medical images, after which the visual features of at least one of the medical images is adjusted to reduce the differences and match the visual features of the medical images. The medical images are then displayed to a user on a display.

By identifying and matching visual features of at least two related medical images, the systems and methods described herein aid a user in reviewing the medical images by saving the user significant time and effort that would otherwise be spent altering the images manually. The overall work flow of medical image screening and diagnosis will be improved. Additionally, the systems and methods described herein are capable of automatically adjusting many types of visual features, and can also adjust the visual features of both images as opposed to only one. Additional embodiments provide for adjusting the medical images to a predefined value for each visual feature so that both images not only match, but are also adjusted to a desired level of clarity that is preferred by the user.

The user viewing the medical image, for example a radiologist, can therefore more clearly view and more accurately identify any potential physiological abnormalities without being distracted by non-relevant visual differences. Any anatomical or pathological differences between the images appear more prominent to the radiologist because other visual differences are diminished or eliminated entirely.

The inventive systems and methods are applicable to many types of medical imaging, including but not limited to magnetic resonance imaging (MRI), radiography (x-rays), computed tomography (CT) and ultrasound (US).

The following illustrative embodiments pertain to mammography images, but one skilled in the art will appreciate that the methods and systems described herein can be applied to any medical image of any area of the body that a user may want to compare with a related medical image. For any set of medical images, the inventive systems and methods allow the identify differences in the visual features between the images and adjust the images so that the visual features match.

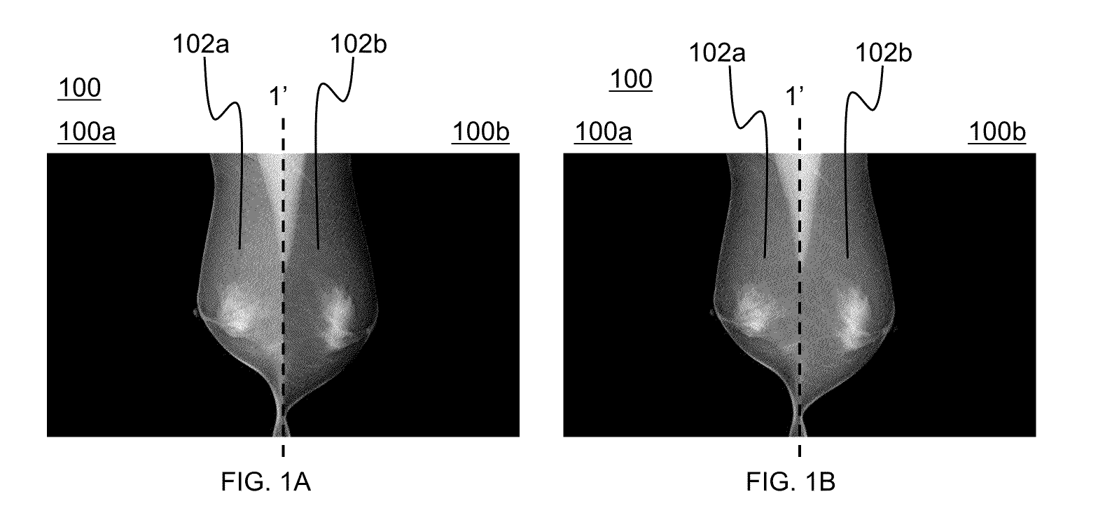

FIG. 1A illustrates a mammography image 100 with a right breast 102a and a left breast 102b. The mammography image 100 is actually two images—a first image 100a of the right breast 102a of a patient, and a second image 100b of the left breast 102b of the patient, placed together in a back-to-back configuration for easy comparison. The dotted line 1′ indicates where the first image 100a and second image 100b are joined together. As can be seen in image 100 in FIG. 1A, the second image 100b appears darker than the first image 100a. In one embodiment of the invention, the differences between visual features of the first and second images are identified, based on techniques described in further detail below. Once the differences are identified, at least one of the first image 100a or second image 100b is adjusted so that the visual features of the images 100a, 100b match. FIG. 1B illustrates one embodiment of the invention where the second image 100b has been adjusted to increase the brightness so that the brightness matches that of the first image 100a. Now that the brightness of both images are similar, the user can more easily identify physiological differences between the left breast 102a and the right breast 102b without needing to figure out if the differences are anatomical or inherent to the image.

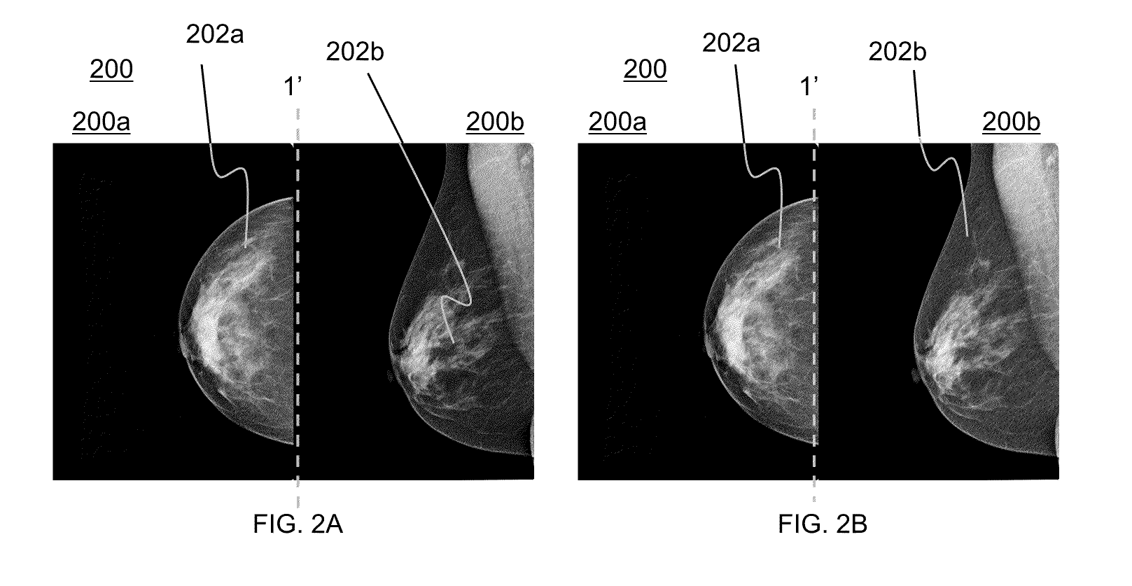

FIGS. 2A and 2B illustrate another embodiment, where two different images of the same breast taken from two different angles can be compared. FIG. 2A depicts a mammography image 200 that is actually another synthesized set of images similar to FIG. 1A—a first mammography image 200a classified as a cranio-caudal (CC) view of a breast 202a and a second mammography image 200b with a medio-lateral oblique (MLO) view of the breast 202b. The dotted line 1′ indicates where the first image 200a and second image 200b are joined together. As can be seen in image 200 in FIG. 2A, the second image 200b appears darker than the first image 200a. In one embodiment of the invention, the differences between visual features of the first and second images are identified, based on techniques described in further detail below. Once the differences are identified, at least one of the first image 200a or second image 200b is adjusted so that the visual features of the images 200a, 200b match. FIG. 2B therefore illustrates one embodiment of the invention where the second image 200b has been adjusted to increase the brightness so that the brightness matches that of the first image 200a. Now that the brightness of both images are similar, the user can more easily identify physiological differences between the CC view of the breast 202a and the MLO view of the breast 202b without needing to figure out if the differences are anatomical or inherent to the image.

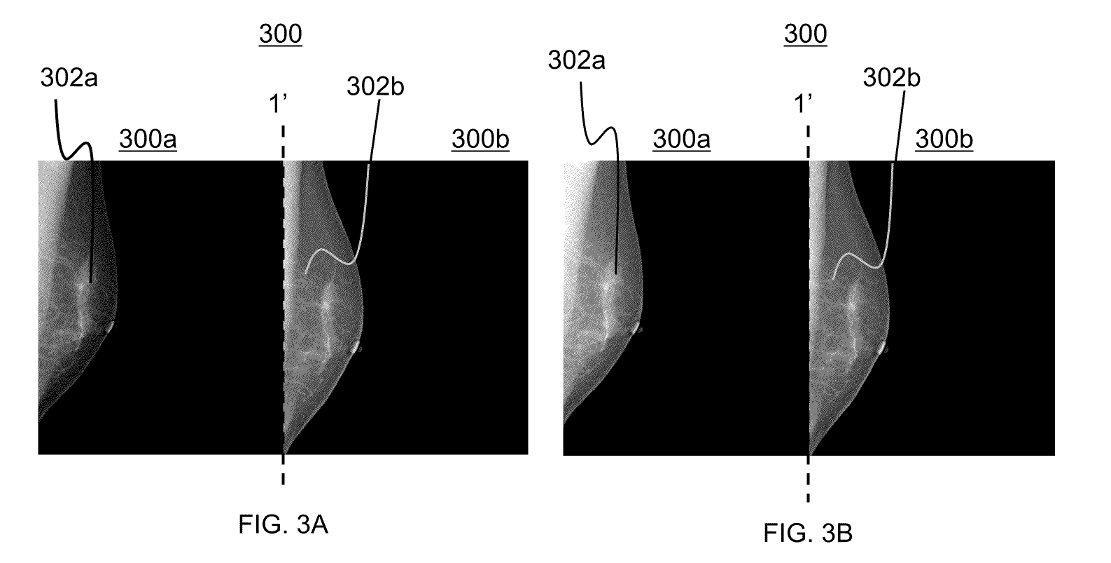

FIGS. 3A and 3B illustrate another embodiment, where two different images of the same breast taken at two different times can be compared to determine if any changes have occurred between the time the two images were taken. FIG. 3A depicts a mammography image 200 that is actually another synthesized set of images similar to FIG. 1A—a first mammography image 300a classified as a medio-lateral (ML) view of a breast 302a taken at a first time, and a second mammography image 300b at the same ML view of the same breast 302b taken at a subsequent time. The dotted line 1′ indicates where the first image 300a and second image 300b are joined together. As can be seen in image 300 in FIG. 2A, the first image 300a appears darker than the second image 300b. In one embodiment of the invention, the differences between visual features of the first and second images are identified, based on techniques described in further detail below. Once the differences are identified, at least one of the first image 300a or second image 300b is adjusted so that the visual features of the images 300a, 300b match. FIG. 3B therefore illustrates one embodiment of the invention where the first image 300a has been adjusted to increase the brightness so that the brightness matches that of the second image 300b. Now that the brightness of both images are similar, the user can more easily identify physiological differences between the breast 302a and the MLO view of the breast 302b without needing to determine if the differences are anatomical or inherent to the image.

It will be appreciated that the differences between any types of visual feature can be identified and calculated for comparison and adjustment, so that the images can be matched as closely as possible. Visual features include, but are not limited to, brightness, contrast, alignment, sharpness (or edge strength) and dynamic range. The values of the visual features that are calculated can then be increased or decreased. For example, the brightness of an image may be increased or decreased depending on the brightness of a corresponding image that it is being matched to. In an alternative embodiment, the brightness of one image is increased while the brightness of a corresponding image is decreased so that both images have a similar brightness level that is at an intermediate point between their original brightness levels.

In one embodiment, the intermediate brightness level may also correspond to a desired level of brightness preferred by a user, which the user can predefine. The image features may be adjusted to match predefined values for all of the image features, or if no predefined values are set, the image features may be adjusted to an intermediate level in order to balance out the visual features of the images. Adjustments to these types of image features do not affect the anatomical or pathological structure in the image.

Adjustments to these visual features can be accomplished by one or more image processing techniques which are understood by one of skill in the art and not explained in detail here. For example, brightness adjustment can be accomplished by simply increasing or decreasing the intensity value of the image. Contrast adjustment can be achieved through histogram equalization, which maps each intensity value to a new value through a mapping curve, such that the intensity difference between different tones in the image is increased. Using different mapping curves results in different changes of the contrast. If the mapping curve leads to a decrease of intensity difference between different tones in the image, the contrast is reduced. The dynamic range is the difference between the highest and the lowest intensity value in the image, which describes how wide a range of intensity values is depicted in the image. Adjustment of the dynamic range can also be accomplished through an intensity value mapping technique, such that the highest and the lowest intensity values are mapped to the desired values. Depending on the design of the mapping curve, the dynamic range and the contrast can be changed simultaneously. Image sharpness (or edge strength) can be enhanced by a known technique called Unsharp Masking. In one implementation of the technique, an edge image is first generated by applying an edge detection filter, such as Sobel filter, to the original image. The edge image is then scaled and added to the original image, resulting in the sharpened image.

In one embodiment, the identification of the differences between visual features can be carried out automatically by a system such as a computer, which receives the original images and processes the images using image processing techniques to determine the values of the visual features of the image and compute the feature difference between different images. For example, the brightness of an image is generally represented by the location of the histogram along the intensity axis. Thus, the brightness difference between two images can be evaluated by calculating the histogram overlapping area. Generally, larger overlapping area indicates smaller brightness difference. The contrast difference can be evaluated by comparing the span of the two histograms, where a broad histogram reflects significant contrast; and narrow histogram reflects less contrast. The dynamic range can be readily obtained by calculating the difference between the highest and the lowest intensity values in the image, and thus is easy to compare. The sharpness of an image can be depicted by the strength of the edges in the image, which is calculated from the edge map generated by an edge detection filter such as Sobel filter.

Once the values for the visual features and the differences between the values of the plurality of medical images are determined, the appropriate adjustments to one or more of the images need to be decided. One embodiment of the invention is to select one of the images as the reference image. Then the other images are adjusted to match the reference image. The reference image is determined according to the user's preference, which can be selected by using a computer input device, such as a mouse, from the image display. The reference image can also be selected automatically by the system according to a predefined setting. For example, it can be predefined that the brightest image is the reference for brightness matching; and the image with the highest contrast is the reference for contrast matching. A similar predefined setting can also be applied to image sharpness and dynamic range; or simply the first image that is loaded into the computer is used as the reference image. To avoid a situation where the visual features of the reference image have extreme values, for example, too bright or too dark, it is desired to select an image which has middle level feature values. For example, if a pixel intensity value is represented by an 8-bit digit, the pixel intensity value is between 0˜255, and 128 will be the middle intensity value. The image with an average or median intensity value close to 128 can be selected as the reference image. Thus, the too bright or too dark images are adjusted to match the middle level bright image. It is still possible that the reference image selected by the system does not have the visual feature values the user desires. The user may then have the option to interactively adjust the visual feature values to his/her desired level. In this case, instead of adjusting each image one by one, the user can adjust all the images using a single set of parameters, because the images have similar feature values after the invention is applied.

In another embodiment, the system for matching visual features includes predetermined values for each of the visual features that can be adjusted in the images. For example, a certain value for brightness or contrast may be predefined so that the images are all adjusted to the predefined value. In this embodiment, even two poor quality images can both be adjusted to an adequate level of brightness. For example, if an image is represented by N-bit digits, the middle intensity value for the image is (2^{N}−1)/2. We can increase or decrease the intensity value of the image (which is equivalent to shifting the histogram) so that the center of the intensity histogram locates at the (2^{N}−1)/2. The user may be able to set the predefined values to a preferred level, or the system may include predefined values that are generally acceptable for viewing medical images of a certain type, such as x-ray or MRI. For some visual features, such as contrast and sharpness, however, it is unpractical to define a value that is generally suitable, as the personal preference varies greatly among different users, for example radiologists. In this case, interactive adjustment after the feature value matching steps described above is more appropriate.

In another embodiment, the visual features to be adjusted can be selected by the user, so that a user who only needs to adjust certain features can streamline the process without having to commit resources to unnecessary adjustments.

It will be appreciated by one of skill in the art that the systems and methods for adjusting and matching visual features in medical images can also be applied to medical images other than a mammography image, in order to compare related medical images corresponding to other anatomical features or areas of the body. For example, medical images of humans or animals, including the brain, abdomen, arms or legs may need to be compared to determine if abnormalities identified in one medical image appear in another medical image of a similar anatomical area, or of the same anatomical area captured in a previously-acquired medical image.

In one embodiment, the image feature adjustment can be extended to a multi-resolution or multi-spectrum framework to account for differences in the resolution and spectrum of the image. For multi-resolution framework, the invention can be applied to images at different resolutions. The visual feature can be adjusted between a lower resolution image and a high resolution image using the same method for images at the same resolution. For multi-spectrum framework, the images can be decomposed into multiple spectrums using methods such as Wavelet decomposition. Then the visual feature values can be adjusted between the same spectrums for the different images. In another embodiment, regions of interest can be defined in the medical images, so that a user may more easily compare these regions. For example, the radiologist may be only interested in the lower half of the breast when compare the left and right mammography images, then the invention can be applied to just the lower half of the breast for even faster work flow.

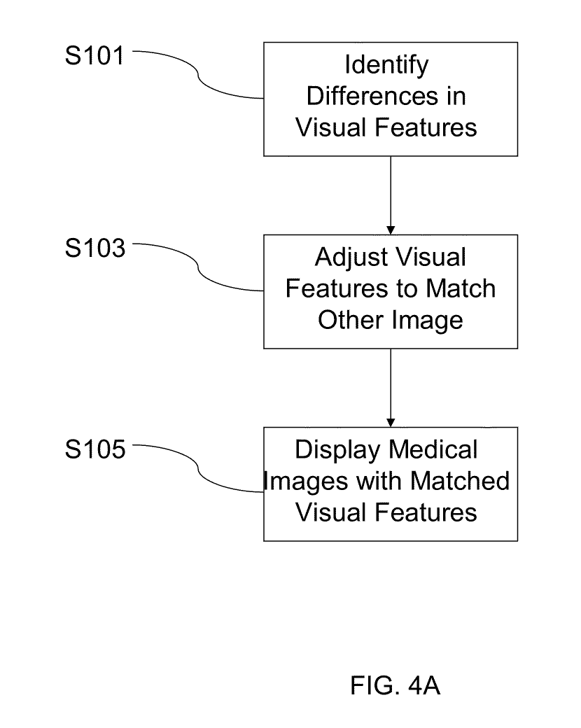

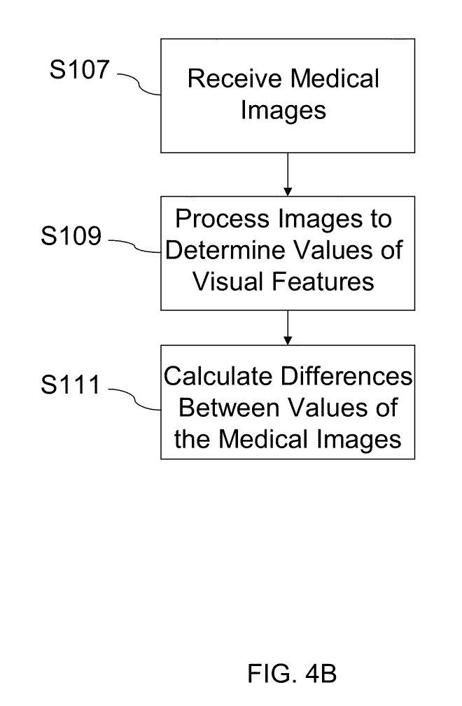

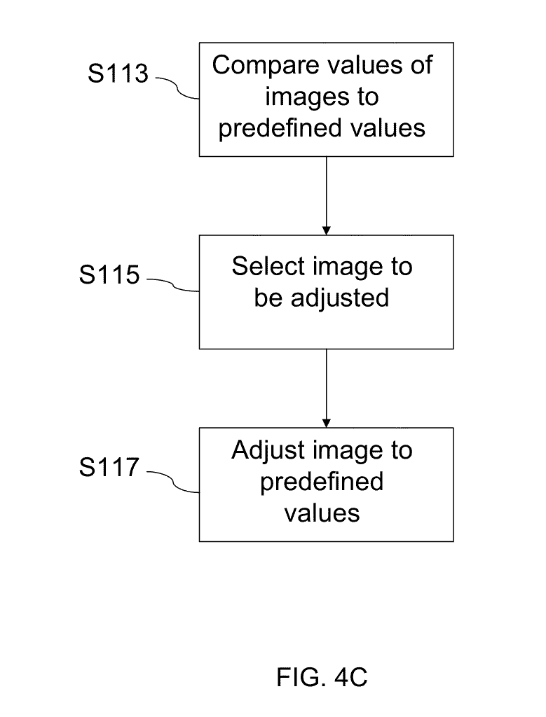

FIG. 4A depicts a method for matching visual features of a plurality of medical images, according to one embodiment of the invention. In a first step S101, the differences between visual features in at least two medical images are identified. In a second step S103, the visual features of at least one of the medical images is adjusted to reduce the differences between the visual features of the at least two medical images. Finally, in step S105, the at least two medical images are displayed.

FIG. 4B depicts one embodiment of more detailed steps of a method of identifying the differences between visual features in at least two medical images, including a first step S107 of receiving a medical image at an image processor such as a computer. The medical image may be received directly from a medical imaging device such as an MRI, or the medical images could be stored after creation and inputted to a computer for processing at a later date. In a second step S109, the medical images are processed using image processing techniques to determine values of at least one visual feature of the images. In a next step S111, the differences between the values of the plurality of medical images are calculated and identified.

FIG. 4C depicts one embodiment of more detailed steps of a method for adjusting at least one of the images to reduce the differences between the visual features of the at least two medical images. In a first step S113, the values of the visual features of the images are compared to predefined values. In a next step S115, at least one of the images is selected for adjustment based on how great the difference is between the predefined values or the values of another image. In a first example, if the value of an image feature in any of the images is more than a certain percentage amount above or below a predefined value, all of the images with higher or lower values would be selected for adjustment. In a second example, if the value of an image feature in one image is below that of another image feature, the image with the lower value image feature will be adjusted while the image with the higher value image feature remains the same. In a further step S117, the selected image is adjusted to the predefined values or the values of another image. In the first example above, where all of the images with higher or lower values than a predefined value would be selected for adjustment, all of the selected images are adjusted to the predefined value for a particular image feature. In the second example given above, where the image with the lower value image feature is selected for adjustment, only that image is adjusted by increasing the value of that particular image feature to the same value as the other image. The methods described above can be applied to adjust only one or multiple images, and each image can be adjusted by increasing or decreasing the value of one or more image features of the image.

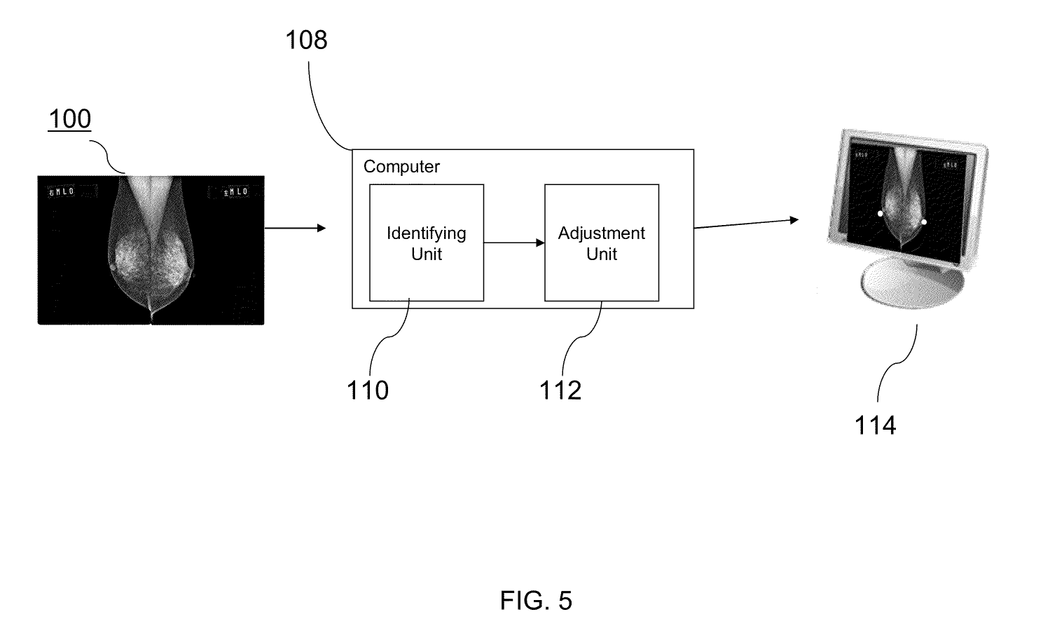

The inventive system may be implemented on a computer which receives the medical image and processes it according to the steps described above. The inventive system may be embodied as a computer program product or carried out by a combination of software and hardware. As illustrated in FIG. 5, a composite image 100 may be input to the computer 108 where an identifying unit 110 identifies the differences between the visual features of at least two medical images. An adjustment unit 112 then adjusts at least one of the visual features of at least one of the medical images to reduce the differences between the visual features of the at least two medical images. Finally, a display unit 114 displays the medical images. In one non-limiting embodiment, the system provides the adjusted one or more medical images as an option to the user, so that the user can compare the adjusted medical image to the original unaltered image.

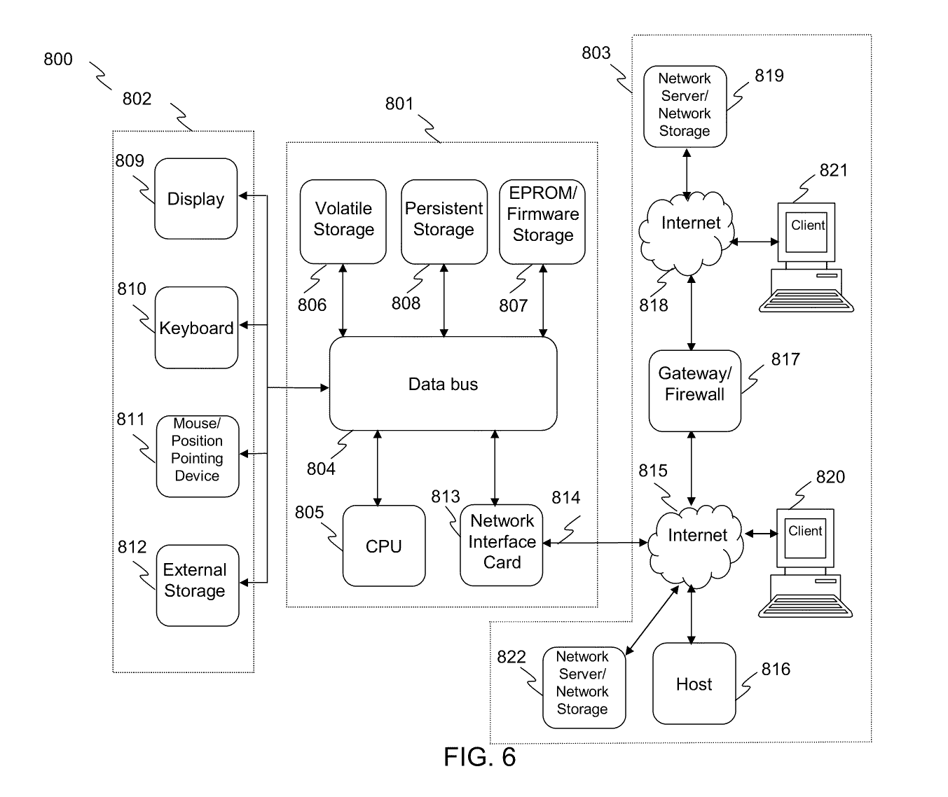

FIG. 6 is a block diagram that illustrates an embodiment of a computer/server system 800 upon which an embodiment of the inventive methodology may be implemented. The system 800 includes a computer/server platform 801, peripheral devices 802 and network resources 803.

The computer platform 801 may include a data bus 804 or other communication mechanism for communicating information across and among various parts of the computer platform 801, and a processor 805 coupled with bus 801 for processing information and performing other computational and control tasks. Computer platform 801 also includes a volatile storage 806, such as a random access memory (RAM) or other dynamic storage device, coupled to bus 804 for storing various information as well as instructions to be executed by processor 805. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 801 for storing information and instructions.

Computer platform 801 may be coupled via bus 804 to a display 809, such as a cathode ray tube (CRT), plasma display, or a liquid crystal display (LCD), for displaying information to a system administrator or user of the computer platform 801. An input device 820, including alphanumeric and other keys, is coupled to bus 801 for communicating information and command selections to processor 805. Another type of user input device is cursor control device 811, such as a mouse, a trackball, or cursor direction keys for communicating direction information and command selections to processor 804 and for controlling cursor movement on display 809. This input device typically has two degrees of freedom in two axes, a first axis (e.g., x) and a second axis (e.g., y), that allows the device to specify positions in a plane.

An external storage device 812 may be connected to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 808. Volatile media includes dynamic memory, such as volatile storage 806. Transmission media includes coaxial cables, copper wire and fiber optics, including the wires that comprise data bus 804.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is connected to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 813 typically provides data communication through one or more networks to other network resources. For example, network link 814 may provide a connection through local network 815 to a host computer 816, or a network storage/server 817. Additionally or alternatively, the network link 813 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 814 and communication interface 813. In the Internet example, when the system 801 acts as a network server, it might transmit a requested code or data for an application program running on client(s) 820 and/or 821 through Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution. In this manner, computer system 801 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the computerized storage system. It is intended that all matter contained in the above description or shown in the accompanying drawings shall be interpreted as illustrative only and not limiting.

What is claimed is:

1. A method for matching visual features of a plurality of medical images, the method comprising:
identifying differences between visual features in at least two related medical images;
adjusting at least one of the visual features of at least one of the medical images to reduce the differences between the visual features of the at least two medical images; and
displaying the at least two medical images on a display after said adjusting is performed.

2. The method of claim 1, wherein the differences between visual features in the at least two medical images are automatically identified.

3. The method of claim 2, wherein the at least one of the visual features of at least one of the medical images is automatically adjusted.

4. The method of claim 3, wherein the medical images are mammography images, and wherein a first mammography image depicts a left breast of a patient, and wherein a second mammography image depicts a right breast of the patient.

5. The method of claim 3, wherein the medical images are mammography images, and wherein a first mammography image depicts a breast of a patient taken at a first time, and wherein a second mammography image depicts the breast of the patient taken at a subsequent time.

6. The method of claim 1, wherein the visual features include at least one of brightness, contrast, sharpness (or edge strength) and dynamic range.

7. The method of claim 6, wherein the visual features are adjusted through at least one of histogram shifting, histogram equalization (or intensity value mapping) and Unsharp Masking.

8. The method of claim 6, wherein the visual features to be adjusted are selected by a user.

9. The method of claim 1, wherein the at least one of the visual features of the at least one medical images is adjusted to a predefined value, wherein the predefined value may be unique for each visual feature.

10. The method of claim 1, wherein the at least one of the visual features of the at least one medical images is adjusted to match at least one of the visual features of another of the at least two medical images.

11. A system for matching visual features of a plurality of medical images, the system comprising:
an identification unit which identifies differences between visual features in at least two medical images; and
an adjustment unit which adjusts at least one of the visual features of at least one of the medical images to reduce the differences between the visual features of the at least two medical images.

12. The system of claim 11, further comprising a display unit which displays the at least two medical images after said adjusting is performed.

13. The system of claim 11, wherein the differences between visual features in the at least two medical images are automatically identified.

14. The system of claim 13, wherein the at least one of the visual features of at least one of the medical images is automatically adjusted.

15. The system of claim 14, wherein the medical images are mammography images, and wherein a first mammography image depicts a left breast of a patient, and wherein a second mammography image depicts a right breast of the patient.

16. The system of claim 14, wherein the medical images are mammography images, and wherein a first mammography image depicts a breast of a patient taken at a first time, and wherein a second mammography image depicts the breast of the patient taken at a subsequent time.

17. The system of claim 11, wherein the visual features include at least one of brightness, contrast, sharpness (or edge strength) and dynamic range.

18. The system of claim 17, wherein the visual features are adjusted through at least one of histogram shifting, histogram equalization (or intensity value mapping) and Unsharp Masking.

19. The system of claim 17, wherein the visual features to be adjusted are selected by a user.

20. The system of claim 11, wherein the at least one of the visual features of the at least one medical images is adjusted to a predefined value, wherein the predefined value may be unique for each visual feature.

21. The system of claim 11, wherein the at least one of the visual features of the at least one medical images is adjusted to match at least one of the visual features of another of the at least two medical images.

22. A computer program product for matching visual features of a plurality of medical images, the computer program product embodied on a computer readable medium and when executed by a computer, performs the method comprising:
identifying differences between visual features in at least two medical images;
adjusting at least one of the visual features of at least one of the medical images to reduce the differences between the visual features of the at least two medical images; and
displaying the at least two medical images on a display after said adjusting is performed.
